(19) United States
(12) Patent Application Publication
(10) Pub. No.: US 2006/0033441 A1
(43) Pub. Date: Feb. 16, 2006

(54) Index tube with tracking structures

(76) Inventors: Andrea Notari, Eindhoven (NL); Franciscus Paulus Maria Budzelaar, Endhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/524,992

(22) PCT Filed: Jul. 21, 2003
(86) PCT No.: PCT/IB03/03294

§ 371 Date: Feb. 18, 2005

(30) Foreign Application Priority Data
Aug. 23, 2002 (EP) 02078497.1

(51) Int. Cl. H01J 29/74; H01J 25/22; H04N 5/225; H01J 29/76; G09G 1/04

(52) U.S. Cl. 315/5.24; 348/170; 315/369

(57) ABSTRACT

The invention is related to a cathode ray tube of the index type (1). Tracking elements (16,18) from a tracking structure flank, preferably above and below each phosphor element (20), being provided on an inner surface of a screen (10). A tracking signal that is derived from response signals from the tracking elements, is used to keep the electron beam (7,8,9) on the right phosphor element. In the index tube according to the invention a part of the tracking lines is provided with gaps (30, 30′). The gaps generate an interruption in the tracking signal. This interruption can inter alia be used to derive the precise position of the electron beam (7,8,9) on the screen (10), especially during the star-up phase of the tube.

The invention relates to a cathode ray tube of the index type, the tube comprising a gun for generating an electron beam, deflection means for deflecting the electron beam across an inner surface of a screen, the inner surface of the screen being provided with phosphor elements for generating light when being excited by the electron beam, tracking structures provided at the inner surface of the screen for deriving a positioning signal corresponding to the position of the beam on the screen, the tracking structures comprising tracking elements extending substantially parallel to each other, the tracking elements being positioned such that each phosphor element is flanked by two tracking elements.

Cathode ray tubes of the index type operate without a shadow mask. An inner screen is provided with phosphor elements that extend in a direction, preferably the horizontal direction. Each phosphor element is flanked, preferably above and below it, by tracking elements belonging to a tracking structure. Proper landing of the electron beam on the desired phosphor elements (conventionally the phosphors generate red, green and blue light) is assured by using a correction signal that contains information about the deviation of the electron beam from the ideal position on the phosphor element. The tracking elements comprise phosphors that excite light when being hit by the electron beam. The phosphors of the tracking elements positioned above the phosphor elements excite with a first wavelength and the phosphors of the tracking elements positioned below the phosphor elements excite with a second wavelength when being hit by the electron beam. The excited light is detected by two photo-detectors, a first detector being sensitive to the first wavelength, and a second detector being sensitive to the second wavelength. The signals from the two detectors are used to derive the correction signal for correcting the position of the electron beam in case it deviates from the ideal path over the phosphor element.

A critical point in the control of the conventional index tube is that the tube must produce a good-quality picture, even very quickly after it has been switched on. During switch-on there is little time to make adjustments to the beam. By using the control parameters as they were at the moment of switching off the television set, the starting point for the adjustment is usually quite good, Even so, it is desired that the initial calibration of the television set is swift and accurate.

It is an object of the invention to provide a cathode ray tube of the index type in which the calibration is swift and accurate. To this end the cathode ray tube according to the invention is characterized in that a subset of the tracking elements has gaps for deriving an additional positioning signal for positioning the electron beam. By providing a subset of the tracking elements with gaps, a temporary interruption of the correction signal is generated when the electron beam is at a well defined position on the screen. This interruption is additionally used to control the electron beam, in particular during the start-up period of the television set.

The dependent claims describe advantageous embodiments of the invention.

These and other objects of the invention will be apparent from and elucidated with reference to the embodiments described hereinafter.

In the drawings:

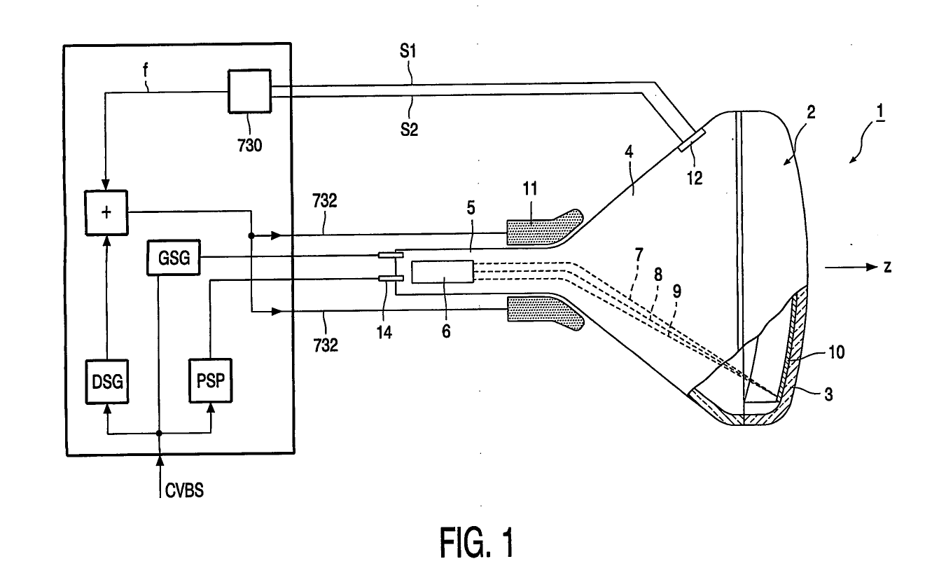

FIG. 1 shows a cross-section of an index type CRT according to the invention,

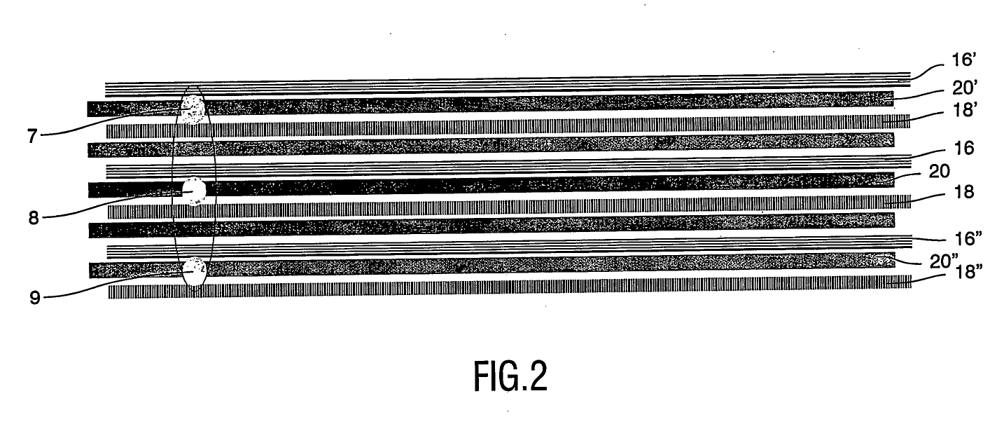

FIG. 2 shows a tracking structure of a conventional index type CRT,

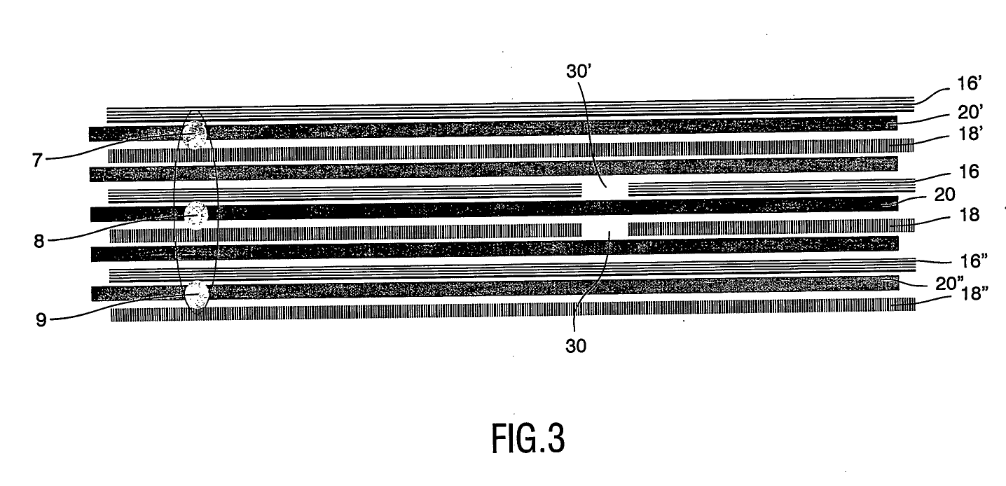

FIG. 3 shows a first embodiment of a tracking structure according to the invention, and

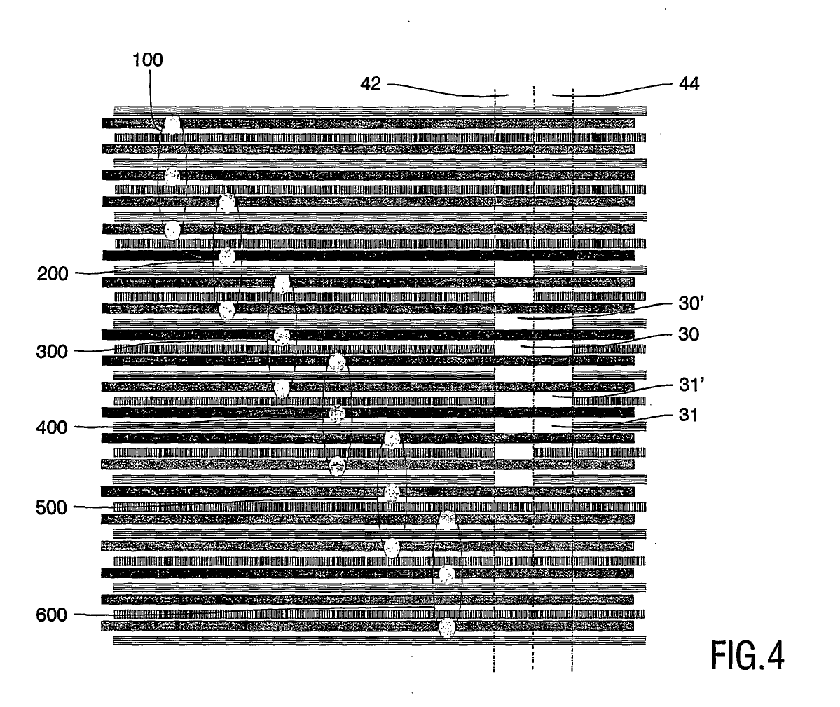

FIG. 4 shows a second embodiment of a tracking structure according to the invention.

The figures are not drawn to scale. In the figures, like reference numerals generally refer to like parts.

The cathode ray tube shown in FIG. 1 is an index type color cathode ray tube according to the invention 1 having an evacuated envelope 2 comprising a display window 3, a cone 4 and a neck 5. The neck 5 accommodates an electron gun 6 for generating electron beams 7, 8 and 9 extending, in this embodiment, in one plane, the in-line plane. In the in-plane configuration, there are two side beams and one central electron beam. A display screen 10 comprises a plurality of red, green and blue-luminescing phosphor elements. On their way to the display screen 10, the electron beams 7, 8 and 9 are deflected across the display screen 10 by means of a deflection unit 11.

The tube further comprises an element 12 from which a first response signal S1 and a second response signal S2 are fed to a deflection correction generator 730 that generates a deflection correction signal f based on the two response signals. A Composite Video Baseband Signal (CVBS) is applied to a Deflection Signal Generator (DSG) for generating a deflection signal, to a Picture Signal Processor (PSP) for generating a picture signal for gun 6 and to a Grid Signal Generator (GSG) for generating a signal for grid elements 14. The deflection signal f is combined with the deflection signal from the DSG and used as deflection signal 732 for the deflection unit 11.

It should be noted that to illustrate the invention the tube shown in FIG. 1 has three electron beams. This is not necessary however; the invention may very well be used in index tubes having a single electron beam.

FIG. 2 shows a detail of a tracking structure of a conventional cathode ray tube of the index type. The tracking structure is located on an inner surface of the screen 10, which has phosphor elements 20,20′,20″. Tracking elements 16, 16′, 16″ and 18, 18′, 18″ extend parallel (preferably horizontally) to the phosphor elements. Tracking elements 16 and 18 are positioned adjacent to phosphor element 20. The tracking elements comprise a fast-decaying phosphor material.

Simultaneously, the three electron beams 7,8,9 are scanned over the phosphor elements. Each beam scans over a phosphor element emitting either red light (in the case of electron beam 7), green light (electron beam 8) or blue light (electron beam 9), thus forming a pixel element. For reasons of conciseness, the terms red, green and blue electron beam, respectively, will be used. When the electron beam, for example electron beam 8, hits the tracking element 16, which is located above the phosphor element 20, light of a first wavelength is emitted and registered by a first photo-detector located on or in the tube. When electron beam 8 hits the tracking element 18 located below the phosphor element 20, however, light of a second wavelength is emitted and registered by a second photo-detector. When electron beam 8 impinges on phosphor element 20, it will also impinge on tracking elements 16 and 18. When the electron beam evenly impinges on tracking elements 16 and 18, there will be no difference in response signals from the tracking elements. When the electron beam is shifted upwards or downwards, more electrons will impinge on one tracking element than on the other, and a difference in response signals will occur. This difference can be measured and used for correcting the position of the electron beam 8 with respect to phosphor element 20.

FIG. 3 shows an index structure according to the invention in case of a three electron beam tube. The tracking elements 16, 18 above and below phosphor element 20 are provided with gaps 30, 30′. If the green beam 8 is deflected across the phosphor element 20 the response signals derived from tracking elements 16,18 are interrupted when the electron beam scans the gaps 30,30′. Since the location of the gaps on the screen is exactly known, the interruption in the signals indicates the precise location of the electron beam 8 on the screen, and may therefore be used for determination of the position of the electron beam(s). Such position information may be required during the start-up phase of the television set, when even very quickly after switch-on good-quality pictures are required and limited time is available to make adjustments.

In a further embodiment, the tracking elements of several adjacent phosphor elements are provided with a gap, such that the gaps form a column that extends in the vertical direction, i.e. the direction perpendicular to the direction in which the tracking elements extend. This structure has the advantage that it allows to derive information on the position of several electron beams.

In an advantageous embodiment, gaps 30,30′ of m adjacent phosphor elements form part of a first column 42, and gaps 31,31′ of n adjacent phosphor elements form part of a second column 44. Both columns extend in a direction perpendicular to the tracking elements. The first 42 and the second column 44 are positioned adjacent to each other. In FIG. 4 an embodiment is shown in which m is equal to nine and n is equal to five, while the first and the second column are positioned symmetrically with respect to each other, i.e. centers of the columns are positioned on the same phosphor element. In view of its shape, this structure is also called T-structure.

The purpose of the first column (which is scanned first in time, as scanning in this example takes place from left to right) is to provide a start-of-structure signal, that can be detected even if the macroscopic correction is completely wrong.

If the tracking of the electron beams is good, only the scanning of four scan lines is influenced by this structure (in one scan three beams are scanned along three phosphor lines, four of these scans are effected). The three beams at positions 100 and 600 will miss the structure. In the first column 42 of the structure the three beams at positions 200 and 500 will be negatively influenced by the structure. At both positions the green beam (i.e. the one in the middle) will hit only one of the two tracking elements, so the tracking signal can not be used temporarily.

At positions 300 and 400, the electron beams hit the first column 42 of the structure; there will be no tracking signal at all. This condition allows a reliable detection of the start of the structure, even when live video is shown. In the second column 44, the tracking signal will come only from the red beam in the case of position 300, and only from the blue beam in the case of position 400.

The embodiment of the invention shown in FIG. 4 has additional advantages related to raster correction, convergence and focus of the electron beam. These advantages will be explained hereinafter.

Raster Correction

If the tracking is wrong, the first column of the structure can still be detected quite easily. Therefore, getting the macroscopic tracking aspects of the tracking right is greatly simplified by the presence of this structure. During the calibration phase, a uniform green test pattern can be displayed. The photo-detectors will generate a signal in which the structures are easily detectable. Pattern matching algorithms produce position information with a resolution better than one phosphor line. This gives immediate absolute horizontal and vertical position information about the scanned raster, and thus control settings of the tube like width, height, linearity etc can easily be adjusted.

As information is required from all screen areas, a large number of these T-structures are required. They can be placed at the positions of an x by y-matrix that covers the whole screen. The ideal number and horizontal width of these positions depend on a large number of aspects, such as: bandwidth of the optical detection mechanism, horizontal spot size and maximum correctable misalignment, etc.

A matrix of 9 by 9 T-structures has proved to be a practical value.

Convergence

Convergence can be measured at the position of the T-structure, without special requirements on the video contents, other than that it should not be completely black. Assuming that the macroscopic position is correct, and that the microscopic tracking keeps the combined three beams on track, the structures provide convergence information in the second column, which allows the red and blue side beams to be adjusted so that the vertical distance between the three beams is correct.

In the area outside the structure, the measured tracking signal is a weighted average of the contribution of the red, green and blue beams. The weight is dependent on the video contents, and therefore not controlled by the tracking system itself. However, in the second column of the structure, the beams at position 300 in FIG. 4 will generate a tracking signal which only depends on the red beam, and at position 400 it only depends on the blue beam. If there is a difference between the weighted signal from red, green and blue, and the signal that is only dependent on red, it is clear that the red side beam is off-track. How much it is off-track cannot be determined, as the video information can differ between these two measurements. But the sign of the difference signal is always correct, and can be used to adjust the red side beam in small steps into the proper direction. This is a proper method, as convergence errors have a slow drift behavior. In order to prevent images that do not contain red at the position of the structure, the adjustments must not be performed when the measured signal drops below a specific threshold value. The same method is to be applied to the blue beam.

The advantage of this method is that it can be performed during operation of the tube, not only within the start-up phase of the television set, and without visible interference.

Focus

A global focus adjustment can be performed by minimizing the signal level that is generated by the two tracking phosphors: the better the spot size in the vertical direction, the lower the number of electrons hitting tracking phosphors. In the conventional tracking structure, only the combined focus can be judged, and the contributions per color depend on the video content shown (a situation similar to that of the position error described above).

The above structures allow the focus of the red and blue beam to be measured separately, thereby greatly simplifying the adjustment of the focus of all three beams.

In summary, the invention is related to a cathode ray tube of the index type 1. Tracking elements 16,18 from a tracking structure flank, preferably above and below each phosphor element 20 are provided on an inner surface of a screen 10. A tracking signal that is derived from response signals from the tracking elements, is used to keep the electron beam 7,8,9 on the right phosphor element. In the index tube according to the invention a part of the tracking lines is provided with gaps 30, 30′. The gaps generate an interruption in the tracking signal. This interruption can inter alia be used to derive the precise position of the electron beam 7,8,9 on the screen 10.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements.

1. A cathode ray tube (1) of the index type, the tube comprising
a gun (6) for generating an electron beam (7,8,9),
deflection means (11) for deflecting the electron beam (7,8,9) across an inner surface of a screen (10), the inner surface of the screen being provided with phosphor elements (20,20′,20′) for generating light when being excited by the electron beam (7,8,9),
a tracking structure provided at the inner surface of the screen (10) for deriving a positioning signal (f) corresponding to the position of the beam on the screen, the tracking structure comprising tracking elements (16,18) extending substantially parallel to each other, the tracking elements (16,18) being positioned such that each phosphor element (20) is flanked by two tracking elements,
wherein a subset of the tracking elements (16,18) have gaps (30,30′) for deriving an additional positioning signal for positioning the electron beam.

2. A cathode ray tube of the index type according to claim 1, wherein gaps (30,30′) of m adjacent phosphor elements form a first column (42) and gaps (31,31′) of n adjacent phosphor elements form a second column (44), both columns (42,44) extending in a direction perpendicular to the tracking elements (20), the first (42) and the second (44) column being positioned adjacent to each other.

3. A cathode ray tube of the index type according to claim 2, wherein m is equal to nine and n is equal to five, while the first (42) and the second (44) column are positioned symmetrically with respect to each other.

4. A cathode ray tube of the index type according to claim 4, wherein the first and the second column form a T-structure, and the inner surface of the screen is provided with a set of T-structures that are distributed over the screen according to the positions of an x by y-matrix.

5. A cathode ray tube of the index type according to claim 4, wherein x and y are equal to nine.
